(19) United States
(12) Patent Application Publication
(10) Pub. No.: US 2020/0117197 A1
(43) Pub. Date: Apr. 16, 2020

(54) Obstacle detection assembly for a drone, drone equipped with such an obstacle detection assembly and obstacle detection method

(71) Applicant: Parrot Drones, Paris (FR)

(72) Inventors: Maher Oudwan, Paris (FR); Henri Seydoux Fornier de Clausonne, Paris (FR)

(21) Appl. No.: 16/596,449

(22) Filed: Oct. 8, 2019

(30) Foreign Application Priority Data
Oct. 10, 2018 (FR) 1859387

(51) Int. Cl. G05D 1/00; B64C 39/02; B64D 47/08; G05D 1/10

(52) U.S. Cl. CPC G05D 1/0094; B64C 39/024; B64D 47/08; B64C 2201/027; B64C 2201/141; B64C 2201/146; B64C 2201/108; G05D 1/101

(57) ABSTRACT

The obstacle detection assembly is provided for a rotary wing drone, and comprises an obstacle detection device having a motorized detection rotating support configured to be fastened on the drone, and an obstacle detection unit carried by the detection rotating support, the obstacle detection unit bearing at least one obstacle detection sensor and having a line of sight, and an orientation module configured to command the detection rotating support so as to orient the line of sight of the obstacle detection unit as a function of the movement direction of the drone bearing the detection rotating support.

### CROSS-REFERENCE TO RELATED APPLICATIONS

This patent application claims the benefit of FR 18 59387 filed on Oct. 10, 2018, which is incorporated herein by reference in its entirety.

### TECHNICAL FIELD

The present invention relates to the field of rotary wing drones, and in particular obstacle detection on the path of a rotary wing drone.

### BACKGROUND OF THE INVENTION

It is possible to pilot a rotary wing drone remotely, for example by using a camera on board the drone and the images of which are sent to a remote piloting device so as to allow the pilot to see what is located in front of the drone.

A drone can also be piloted autonomously by an automatic pilot, on board the drone or piloting the drone remotely, by using the images supplied by a camera on board the drone.

However, when the drone is faced with an obstacle on its path, it may prove difficult for the human pilot or for the automatic pilot to find an efficient way around the obstacle.

### SUMMARY OF THE INVENTION

One of the aims of the invention is to propose an obstacle detection device that facilitates the piloting of a rotary wing drone.

To that end, the invention proposes an obstacle detection assembly for a rotary wing drone, comprising an obstacle detection device having a motorized detection rotating support configured to be fastened on the drone, and an obstacle detection unit carried by the detection rotating support, the obstacle detection unit bearing at least one obstacle detection sensor and having a line of sight, and an orientation module configured to command the detection rotating support so as to orient the line of sight of the obstacle detection unit as a function of the movement direction of the drone bearing the detection rotating support.

The obstacle detection unit carried by the detection rotating support intended to be fastened on the drone can be oriented relative to the drone in order to look substantially in the direction of movement of the drone, which can be separate from the roll axis of the drone and/or the line of sight of a camera used to pilot the drone.

When a first obstacle appears in front of the drone, it is in particular possible to keep the drone oriented toward this first obstacle, to move the drone laterally by pointing the obstacle detection unit on the side of the drone to detect a potential second obstacle located on the side of the drone, until the drone is laterally offset relative to the first obstacle and can continue to advance.

In specific exemplary embodiments, the obstacle detection assembly comprises one or several of the following optional features, considered alone or according to all technically possible combinations:
the orientation module is configured to command the detection rotating support such that the orthogonal projection of the line of sight on the reference plane defined by the roll axis and the pitch axis of the drone coincides with the orthogonal projection of the direction of movement of the drone on this reference plane;
the orientation module is configured to command the detection rotating support such that the projection of the line of sight on the horizontal plane coincides with the orthogonal projection of the direction of movement of the drone on this reference plane;
the detection rotating support is configured to orient the obstacle detection unit around at least two axes of rotation that are perpendicular to one another, and preferably around three orthogonal axes of rotation;
one of the axes of rotation coincides with the yaw axis of the drone;
the orientation module is configured to determine the direction of movement of the drone, for example as a function of piloting instructions received by the drone and/or data supplied by a geolocation device of the drone and/or an inertial unit of the drone;
the obstacle detection unit bears two obstacle detection sensors that are stereovision cameras; and
the obstacle detection unit bears at least one obstacle detection sensor that is a telemetry sensor, each telemetry sensor for example being an optical telemetry sensor, an acoustic telemetry sensor or a radar telemetry sensor.

The invention also relates to a drone equipped with an obstacle detection assembly as defined above, the detection rotating support being fastened on the drone.

The invention further relates to a method for detecting obstacles on the path of a rotary wing drone, comprising the control of a detection rotating support mounted on the drone and bearing an obstacle detection unit having at least one obstacle detection sensor and having a line of sight, so as to orient the line of sight of the obstacle detection unit as a function of the movement direction of the drone.

In specific exemplary embodiments, the obstacle detection method comprises one or several of the following optional features, considered alone or according to all technically possible combinations:
it comprises commanding the detection rotating support such that the projection of the line of sight on the reference plane defined by the roll axis and the pitch axis of the drone coincides with the projection of the direction of movement of the drone on this reference plane;
it comprises commanding the detection rotating support such that the projection of the line of sight on the horizontal plane coincides with the orthogonal projection of the direction of movement of the drone on the horizontal plane.

### BRIEF DESCRIPTION OF THE DRAWINGS

The invention and its advantages will be better understood upon reading the following description, provided solely as a non-limiting example, and done in reference to the appended drawings.

FIG. 1 is a schematic view of a rotary wing drone equipped with an obstacle detection assembly.

FIG. 2 is an enlarged schematic view of zone II in FIG. 1, illustrating an obstacle detection device of the obstacle detection assembly.

FIG. 3 is a schematic perspective view of an obstacle detection assembly illustrating the orientation of an obstacle detection unit of the obstacle detection assembly as a function of the movement direction of the drone.

FIG. 4 is a schematic perspective view of an obstacle detection assembly illustrating the orientation of an obstacle detection unit of the obstacle detection assembly as a function of the movement direction of the drone.

FIG. 5 is schematic top view of the drone of FIG. 1, illustrating obstacle avoidance scenarios.

FIG. 6 is schematic top view of the drone of FIG. 1, illustrating obstacle avoidance scenarios.

### DETAILED DESCRIPTION OF PREFERRED EMBODIMENTS

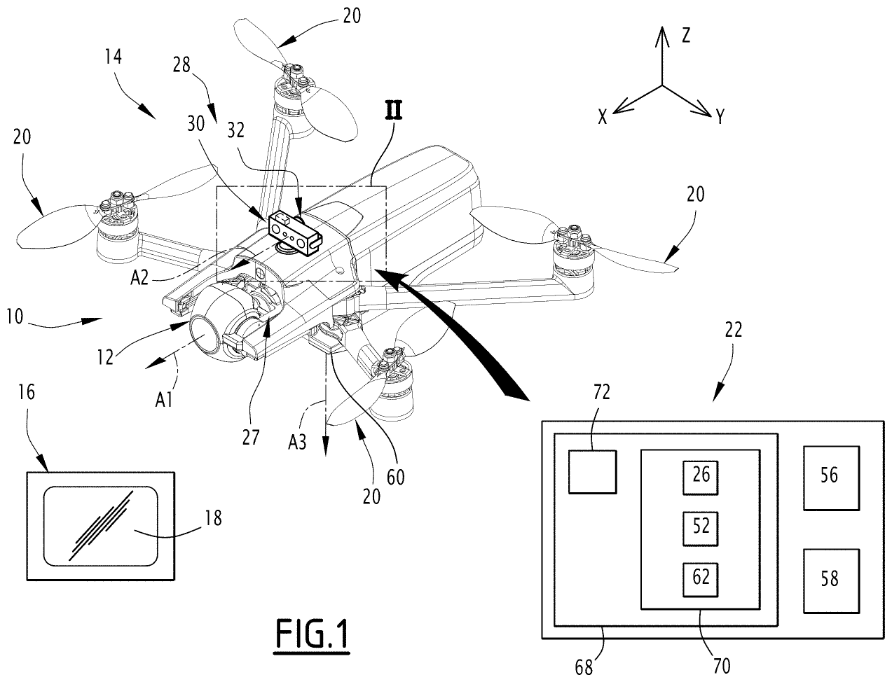

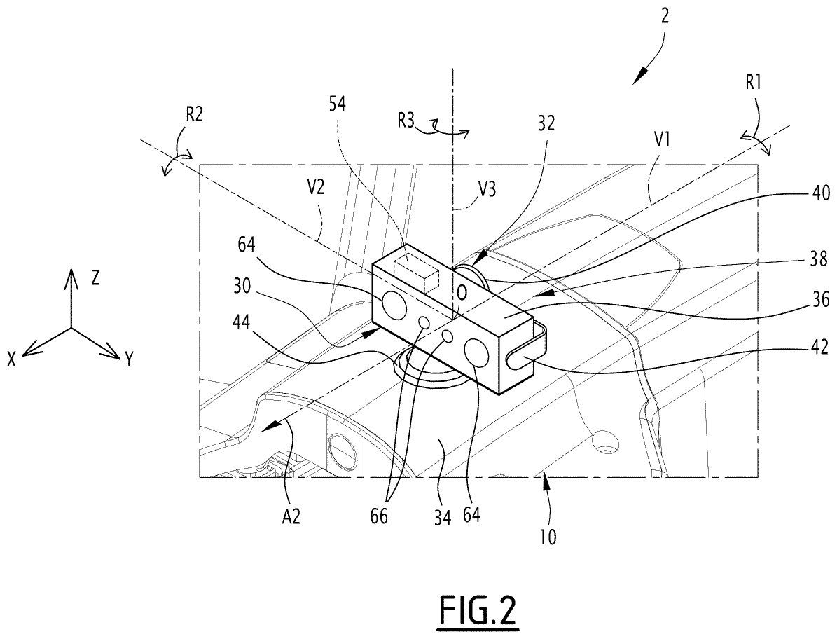

In FIGS. 1 and 2, a drone 10, that is to say, an aircraft with no human pilot on board, is equipped with an observation camera 12 and an obstacle detection assembly 14.

The drone 10 is a self-piloted or remotely piloted motorized flying vehicle, for example via a remote control device 16 equipped with a display screen 18, allowing the user to enter his flight commands and/or to view images acquired by the observation camera 12 and sent by the drone 10.

The remote control device 16 is known in itself. In the example of FIG. 1, the remote control device 16 is made via a smartphone or an electronic tablet. In a variant, the remote control device 16 is a shifter for example comprising at least one moving control member, for example a joystick, a control knob, a cursor, etc.

The drone 10 is a rotary wing drone and includes at least one rotor 20 for ensuring the vertical lift of the drone 10. In FIG. 1, the drone 10 comprises a plurality of rotors 20, and is then called multi-rotor drone. The number of rotors 20 is for example equal to four, and the drone 10 is then called quadcopter drone.

The drone 10 has, in the usual manner, an orthogonal reference coordinate system having a roll axis X, a pitch axis Y and a yaw axis Z. When the drone 10 is hovering, the roll axis X is oriented horizontally from back to front, the pitch axis Y is oriented horizontally from right to left, and the yaw axis Z is oriented vertically from bottom to top.

The drone 10 includes an electronic piloting device 22 configured for the piloting of the drone 10.

The electronic piloting device 22 is preferably configured to exchange data, preferably by radio waves, with one or several pieces of electronic equipment, in particular with the remote control device 16, or even with other pieces of electronic equipment for transmitting the image(s) acquired by the observation camera 12 and/or other pieces of information relative to the drone 10, such as an altitude, an incline, a speed, a flight state, a geographical position and/or a charge of an electric battery equipping the drone 10.

The drone 10 includes a piloting module 26 configured to pilot the drone 10 according to flight instructions from a human pilot or an automatic pilot sent by the remote piloting device 16, and/or to pilot the drone 10 autonomously, in which case the piloting module 26 itself incorporates an automatic pilot.

The observation camera 12 is for example mounted on the drone 10 by means of a motorized observation rotating support 27 (often referred to as “gimbal”) making it possible to modify the orientation of the line of sight A1 of the observation camera 12 relative to the drone 10.

In a variant, the observation camera 12 is mounted fixedly on the drone 10 and is front-viewing, making it possible to obtain an image of a scene toward which the drone 10 is oriented. Also in a variant, the observation camera 12 is mounted fixed on the drone 10 and is vertically-facing, pointing downwards to capture images of terrain overflown by the drone 10.

The observation camera 12 makes it possible to capture images from the drone 10 that can optionally be used to pilot the drone 10, by a human pilot or an automatic pilot.

The obstacle detection assembly 14 is configured to detect any obstacles present on the path of the drone 10.

As is better shown in FIG. 2, the obstacle detection assembly 14 comprises an obstacle detection device 28 comprising an obstacle detection unit 30 and a motorized detection rotating support 32, the obstacle detection unit 30 having a line of sight A2 and being mounted on the drone 10 by means of the detection rotating support 32, so as to be able to modify the orientation of the obstacle detection unit 30 relative to the drone 10 in order to point the obstacle detection unit 30 in a chosen direction.

The obstacle detection device 28 is fastened on the drone 10 so as to be able to detect obstacles on the path of the drone 10. The obstacle detection unit 30 defines the sensitive part of the obstacle detection assembly 14. The obstacle detection unit 30 comprises one or several obstacle detection sensors, as will be described hereinafter.

The detection rotating support 32 is configured to allow the orientation of the obstacle detection unit 30 relative to the drone 10 around at least one axis of rotation, preferably around at least two separate axes of rotation, for example around two separate axes of rotation, in particular two axes of rotation that are perpendicular to one another, still more preferably around three separate axes of rotation, for example three orthogonal axes, preferably concurrent, that is to say, intersecting at a center of rotation.

The detection rotating support 32 here is configured to orient the obstacle detection unit 30 around at least three concurrent orthogonal axes of rotation V1, V2, V3 that intersect at a center of rotation O, as illustrated by the arrows R1, R2, R3, respectively.

The detection rotating support 32 has a stationary part 34 configured to be fastened on the drone 10, a moving part 36 bearing the obstacle detection unit 30, and an articulation assembly 38 connecting the stationary part 34 to the moving part 36 in order to allow the rotation of the moving part 36 with respect to the stationary part 34 around each axis of rotation V1, V2, V3. The articulation assembly 38 for example has a respective articulation 40, 42, 44 associated with each axis of rotation V1, V2, V3.

The detection rotating support 32 is motorized to make it possible to control the orientation of the obstacle detection unit 30. The detection rotating support 32 has at least one orientation motor configured to control the orientation of the obstacle detection unit 30. The detection rotating support 32 for example has a respective orientation motor associated with each axis of rotation V1, V2, V3 in order to modify the orientation of the obstacle detection unit 30 around this axis of rotation V1, V2, V3. Each orientation motor is for example an electric motor or a piezoelectric motor.

The obstacle detection assembly 14 comprises an orientation module 52 (FIG. 1) configured to command the detection rotating support 32, in particular each orientation motor of the detection rotating support 32, so as to orient the line of sight A2 of the obstacle detection unit 30 based on the direction of movement of the drone 10.

Advantageously, the obstacle detection unit 30 is equipped with an inertial measurement unit (IMU) 54 in order to measure the movements and/or the position of the obstacle detection unit 30.

The orientation module 52 is then configured to command the detection rotating support 32 as a function of the data supplied by the inertial measurement unit 54 equipping the obstacle detection unit 30. This allows more precise control of the orientation of the obstacle detection unit 30.

The drone 10 optionally comprises a geolocation device 56 configured to determine the geographical position of the drone 10 as a function of geolocation signals emitted by geolocation satellites, for example a satellite geolocation system such as the GPS system, the GLONASS system or the GALILEO system.

The drone 10 preferably comprises an inertial measurement unit (IMU) 58 configured to determine the orientation of the drone 10, its movements and/or its position.

The orientation module 52 is for example configured to command the detection rotating support 32 as a function of the movement of the drone 10 determined from data coming from the piloting module 26, the geolocation device 56 and/or the inertial measurement unit 58.

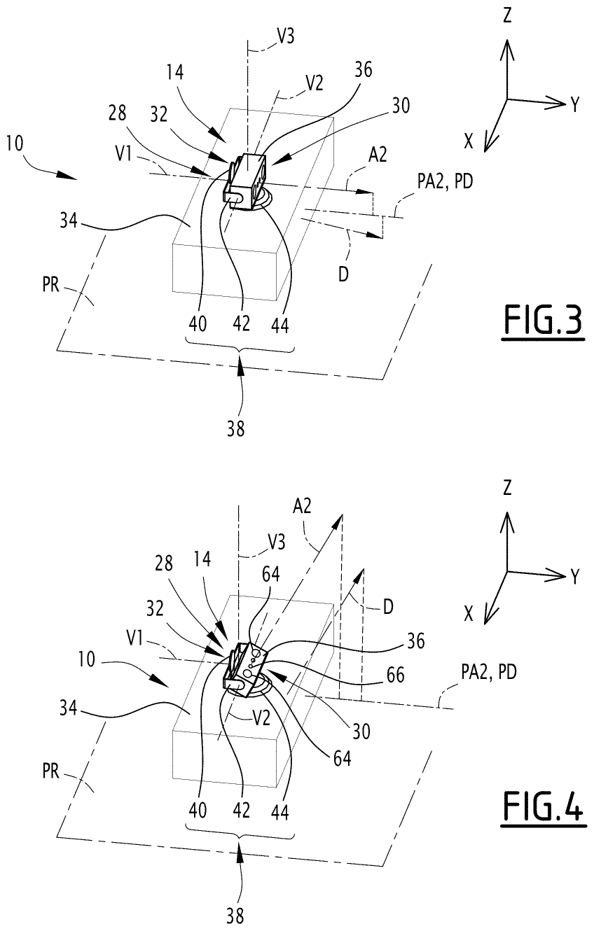

As illustrated in FIGS. 3 and 4, which illustrate two different movement directions D, in one exemplary embodiment, the orientation module 52 is configured to command the detection rotating support 32 such that the orthogonal projection PA2 of the line of sight A2 of the obstacle detection unit 30 on the reference plane PR defined by the roll axis X and the pitch axis Y of the drone 10 coincides with the orthogonal projection PD of the direction of movement D of the drone 10 on this reference plane PR.

In a variant, the orientation module 52 is configured to command the detection rotating support 32 such that the orthogonal projection of the line of sight A2 of the obstacle detection unit 30 on the horizontal plane coincides with the orthogonal projection of the direction of movement D of the drone 10 on this horizontal plane.

In practice, the reference plane PR and the horizontal plane are substantially close for a rotary wing drone 10, such that these two solutions work substantially in the same way. When the drone 10 is hovering, the reference plane PR is combined with the horizontal plane, and when the drone 10 moves, the reference plane PR can form an angle of several degrees with the horizontal plane.

The orientation of the obstacle detection unit 30 such that the orthogonal projection of its line of sight A2 on the reference plane PR or on the horizontal plane coincides with that of the direction of movement of the drone 10 makes it possible to point the line of sight A2 of the obstacle detection unit 20 in the direction in which the drone 10 moves horizontally and is capable of encountering obstacles.

The detection rotating support 32 is for example fastened on top of the drone 10. Due to this position, the obstacle detection unit 30 can be oriented in any direction in the half-space located above the drone 10, and has a blind spot substantially corresponding to the half-space located below the drone 10, since the drone 10 itself prevents the obstacle detection unit 30 from detecting the obstacles located below the drone 10.

Advantageously, as illustrated in FIG. 3, during a horizontal or upward movement of the drone 10, the orientation module 52 is configured to command the detection rotating support 32 such that the line of sight A2 of the obstacle detection unit 30 is substantially parallel to the direction of movement D of the drone 10. This makes it possible to account for the vertical component of the movement of the drone 10.

As illustrated in FIG. 4, during a downward movement of the drone 10, the obstacle detection unit 30 is for example oriented such that its line of sight is substantially horizontal, the projection of the line of sight A2 in the reference plane PR or the horizontal plane coinciding with the projection of the direction of movement of the drone 10 in the reference plane PR or the horizontal plane.

Advantageously, in a known manner, the drone 10 is equipped with at least one obstacle detector 60 (FIG. 1) mounted immobile on the drone 10 and with vertical line of sight A3 oriented downward for the detection of obstacles located below the drone 10 for the movements of the drone having a downward vertical component.

In a variant, the obstacle detection unit 30 is fastened below the drone 10 in order to detect obstacles located in the half-space located below the drone 10.

The detection rotating support 32 is then for example controlled in order to orient the line of sight A2 of the obstacle detection unit 30 substantially along the direction of movement D of the drone 10 during the horizontal movements and downward movements, and/or to orient the line of sight A2 substantially horizontally, the projection of the line of sight A2 on the reference plane or the horizontal plane coinciding with the projection of the direction of movement of the drone 10 on the reference plane or the horizontal plane, during upward movements.

Advantageously, optionally, the drone 10 is then equipped with at least one obstacle detector mounted immobile on the drone 10 and with vertical line of sight oriented upward for the detection of obstacles located below the drone 10 for the movements of the drone 10 having an upward vertical component.

In another variant, the drone 10 is equipped with two obstacle detection devices 28, the obstacle detection unit 30 of one being mounted above the drone 10 in order to detect obstacles located in the half-space located above the drone 10, and the obstacle detection unit 30 of the other being mounted below the drone 10 in order to detect the obstacles located in the half-space located below the drone 10.

The obstacle detection unit 30 comprises at least one obstacle detection sensor allowing the detection of obstacles at a distance along the line of sight A2 of the obstacle detection unit 30.

The obstacle detection assembly 14 comprises an obstacle detection module 62 (FIG. 1) configured to determine the potential presence of an obstacle as a function of data supplied by each obstacle detection sensor of the obstacle detection unit 30.

The obstacle detection unit 30 for example bears two obstacle detection sensors that are stereovision cameras 64 (FIGS. 1 and 2) and that make it possible to detect obstacles by stereoscopic measurement or “stereovision”.

The stereovision cameras 64 each have a respective camera line of sight (not shown), the respective lines of sight of two stereovision cameras 64 being separate. The lines of sight of the two stereovision cameras 62 are for example parallel to one another, while preferably being parallel to the line of sight A2 of the obstacle detection unit 30. In a variant, the lines of sight of the two stereovision cameras 64 define a non-nil angle between them, while preferably being concurrent.

In a known manner, the analysis of two images of the same scene captured by two cameras having distinct lines of sight makes it possible to reconstitute a three-dimensional map of the scene, and thus to detect obstacles in the scene. Thus, the stereovision cameras 62 make it possible to detect obstacles in the scene located in front of the obstacle detection unit 30.

The obstacle detection module 62 is for example configured to analyze the images supplied by the stereovision cameras 64 and determine the presence of any obstacle.

In a variant or optional addition, the obstacle detection unit 30 for example bears at least one obstacle detection sensor that is a telemetry sensor 66, each telemetry sensor 66 being configured to measure a distance with an obstacle.

Each telemetry sensor 66 is for example configured to detect a distance with an object distant along the line of sight A2 from the obstacle detection unit 30.

The obstacle detection unit 30 for example bears at least one optical telemetry sensor 66 using light, at least one acoustic telemetry sensor 66 using acoustic waves and/or at least one radar telemetry sensor 66 using radio waves.

An optical telemetry sensor is for example a laser telemeter (or LIDAR) or a time of flight camera. An acoustic telemetry sensor is for example a sonar. A radar telemetry sensor is for example a radar.

The obstacle detection module 62 is then configured to analyze the data supplied by each telemetry sensor 66 in order to determine any presence of an obstacle. The electronic piloting device 22 is integrated into the drone 10.

The electronic piloting device 22 for example comprises an information processing unit 68, for example made up of a memory 70 and a processor 72.

In the example of FIG. 1, the piloting module 26 is made in the form of software recorded on the memory 70 and executable by the processor 72.

Advantageously, like in the illustrated exemplary embodiment, the orientation module 52 and the obstacle detection module 62 are integrated into the drone 10.

The obstacle detection module 28—formed by the detection rotating support 32 and the obstacle detection module 30—thus receives the orientation commands of the obstacle detection module 30 from the drone 10 and sends the drone 10 the obstacle detection measurements, the drone 10 then being configured to determine the direction in which to orient the obstacle detection unit 30 as a function of the movement of the drone 10, and to decide the movement of the drone 10 as a function of the data supplied by the obstacle detection unit 30, in particular to decide on any stopping of the movement of the drone 10 if an obstacle is detected.

In particular, and like in the illustrated example, the orientation module 52 and the obstacle detection module 62 of the obstacle detection assembly 14 are for example integrated into the electronic piloting device 22, that is to say, into the electronics on board the drone 10.

Thus, it is precisely the electronic piloting device 22 comprising the orientation module 52 and the obstacle detection module 62 that is configured to determine the direction in which to orient the obstacle detection unit 30 as a function of the movement of the drone 10, and to decide the movement of the drone 10 as a function of data supplied by the obstacle detection unit 30, in particular to decide on any stopping of the movement of the drone 10 if an obstacle is detected.

The orientation module 52 and the obstacle detection module 62 are for example each made in the form of software able to be recorded on the memory 70 and executable by the processor 72.

In a variant, at least one from among the orientation module 52 and the obstacle detection module 62 of the obstacle detection assembly 14 is at least partially or fully integrated into the obstacle detection device 28 formed by the detection rotating support 32 and the obstacle detection unit 30.

To that end, for example, at least one from among the orientation module 52 and the obstacle detection module 62 is at least partially or entirely located in an information processing unit separate from that of the electronic piloting device 14, and housed in the obstacle detection device 28, for example housed in the detection rotating support 32 and/or in the obstacle detection unit 30.

In a variant or an optional addition, at least one from among the piloting module 26, the orientation module 52 and the obstacle detection module 62 is made in the form of a programmable logic component, such as an FPGA (Field Programmable Gate Array), or in the form of a dedicated integrated circuit, such as an ASIC (Applications Specific Integrated Circuit), each of these modules then for example being housed in the drone 10 or in the obstacle detection device 28.

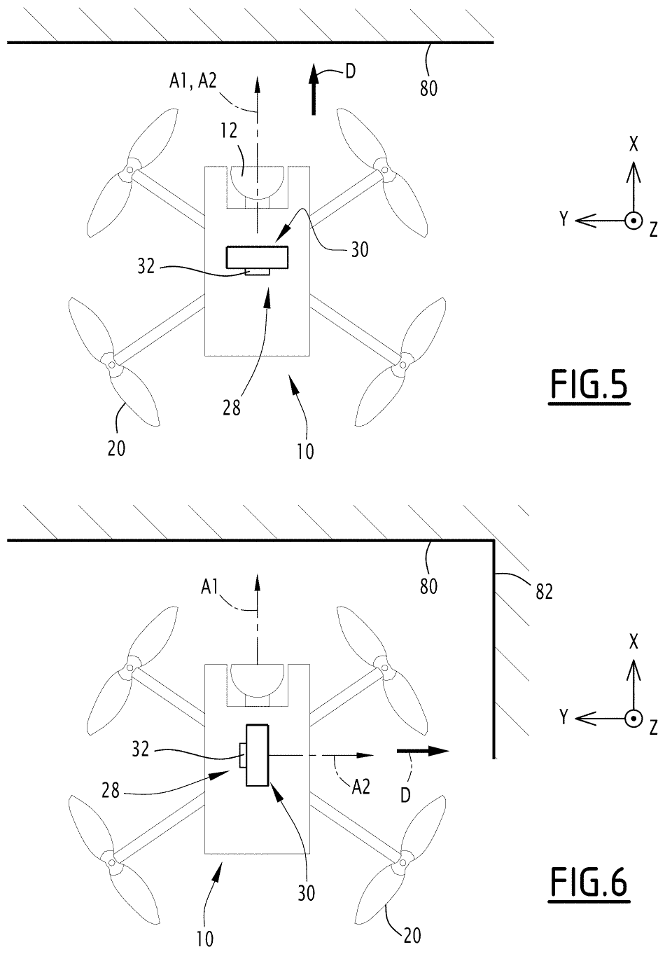

The operation of the drone 10 equipped with the obstacle detection assembly 14 will now be described in reference to FIGS. 5 and 6, which illustrate obstacle avoidance scenarios by the drone 10.

The drone 10 is for example commanded by a human pilot from the remote control device 16 or by an automatic pilot of the piloting module 26, for example configured to pilot the drone 10 to a destination point.

In the illustrated scenario, whereas the drone 10 initially flies horizontally forward in a straight line, an obstacle 80 appears in front of the drone 10 (FIG. 5). The obstacle here is a vertical partition, for example a wall or a rock formation.

The line of sight A1 of the observation camera 12 of the drone 10 is initially oriented upward while optionally being inclined downward. This allows a pilot to see the scene in front of the drone or to see images of the ground in front of the drone.

The line of sight A2 of the obstacle detection unit 30 is oriented horizontally in front of the drone 10, that is to say, along the direction of movement D of the drone 10, to detect any obstacle in front of the drone 10.

The obstacle detection assembly 14 detects the presence of the obstacle 80 in front of the drone 10 and sends this information to the piloting module 26 of the drone 10. The piloting module 26 of the drone 10 stops the drone 10 in front of the obstacle 80 so as not to collide with the obstacle 80.

The human pilot or the automatic pilot then performs a maneuver to avoid the obstacle 80 so as to continue its progression toward the destination point.

To do this, the human pilot or the automatic pilot for example commands the lateral movement of the drone 10 (FIG. 6) while keeping the orientation of the drone 10 and the observation camera 12 unchanged. The drone 10 moves “by quartering”.

The maintenance of the observation camera 12 turned toward the obstacle 80 allows the human pilot or the automatic pilot to continue to see the obstacle 80 in order to determine when the drone 10 will have been offset relative to the obstacle 80 and will be able to continue to advance forward in order to continue its progression.

The orientation module 52 commands the detection rotating support 32 in order to orient the obstacle detection unit 30 to steer its line of sight A2 as a function of the direction of movement of the drone 10, here along the direction of movement of the drone 10, horizontally to the right. Thus, the obstacle detection unit 30 makes it possible to detect any new obstacle 82 in the direction in which the drone 10 moves.

The human pilot or the automatic pilot can therefore keep the observation camera 12 oriented toward the front of the drone 10 and move the drone 10 laterally on the side without risking colliding with a new obstacle 82 located laterally on the side of the drone 10.

When the obstacle detection module 62 detects the presence of a new obstacle 82 on the path of the drone 10 from data captured by the obstacle detection unit 30, the obstacle detection module 62 informs the piloting module 26 thereof, which can optionally decide to stop the drone 10 automatically in order to avoid colliding with this new obstacle 82. The human pilot or the automatic pilot can then perform a new maneuver to avoid the new obstacle 82.

The obstacle detection assembly 14 makes it possible to detect obstacles on the path of the drone 10 with a same obstacle detection unit 30 for different directions of movement of the drone 10 relative to the orthogonal coordinate system of the drone 10.

This makes it possible to move the drone 10 in order to perform a bypass maneuver of the obstacle without orienting the drone 10 or its observation camera 12 in the direction of movement of the drone 10 during the bypass maneuver.

This facilitates the performance of the bypass maneuver by for example making it possible to keep the observation camera 12 pointed at the obstacle to determine the contours thereof, while moving the drone 10 in another direction without risk of colliding with an obstacle.

The drone 10 can further be equipped with at least one obstacle detection sensor 60 mounted stationary on the drone 10 for obstacle detection in a blind spot zone of the obstacle detection assembly 14.

The obstacle detection assembly 14 is for example configured to detect the obstacles in the half-space located above the drone 10, each obstacle detection sensor 60 mounted stationary on the drone 10 being configured for obstacle detection in the half-space located below the drone 10.

In an inverted configuration, the obstacle detection assembly 14 is for example configured to detect the obstacles in the half-space located below the drone 10, each obstacle detection sensor 60 mounted stationary on the drone 10 being configured for obstacle detection in the half-space located above the drone 10.

In such a configuration, the obstacle detection assembly 14 is for example fastened below the drone 10 and/or each obstacle detection sensor mounted stationary on the drone 10 is upwardly vertically-facing.

In one variant, the drone 10 is equipped with two obstacle detection assemblies 14 arranged to detect the obstacles in respective half-spaces.

In all cases, the obstacle detection assembly 14 makes it possible to limit the number of stationary obstacle detectors by handling obstacle detection in an extended spatial zone, typically a half-space of 2π radians or a larger space.

The presence of an observation camera 12 and further of an obstacle detection assembly 14 comprising an obstacle detection unit 30 mounted on a motorized detection rotating support 32 is advantageous independently of the command of the orientation of the obstacle detection unit 30 as a function of the direction of movement of the drone 10.

Thus, according to another aspect, the invention relates to a drone provided with an observation camera mounted on the drone and an obstacle detection assembly comprising an obstacle detection unit mounted on the drone by means of a motorized detection rotating support such that the obstacle detection unit can be oriented relative to the drone.

The observation camera is mounted stationary on the drone or rotating relative to the drone by means of an motorized observation rotating support. The stationary observation camera is for example front-facing or vertical-facing.

The obstacle detection unit bears at least one obstacle detection sensor. The obstacle detection unit for example bears obstacle detection sensors that are stereovision cameras and/or at least one telemetry sensor, in particular an optical telemetry sensor, an acoustic telemetry sensor and/or a radar telemetry sensor.

1. An obstacle detection assembly for a rotary wing drone, the obstacle detection assembly comprising:
an obstacle detection device having a motorized detection rotating support configured to be fastened to the drone; and
an obstacle detection unit carried by the motorized detection rotating support, wherein the obstacle detection unit bears at least one obstacle detection sensor and has a line of sight; and
an orientation module configured to command the motorized detection rotating support so as to orient the line of sight of the obstacle detection unit as a function of a movement direction of the drone bearing the detection rotating support.

2. The obstacle detection assembly of claim 1, wherein the orientation module is configured to command the motorized detection rotating support such that an orthogonal projection of the line of sight on a reference plane defined by a roll axis and a pitch axis of the drone coincides with the orthogonal projection of the movement direction of the drone on this reference plane.

3. The obstacle detection assembly of claim 1, wherein the orientation module is configured to command the motorized detection rotating support such that a projection of the line of sight on a horizontal plane coincides with an orthogonal projection of the movement direction of the drone on this horizontal plane.

4. The obstacle detection assembly of claim 1, wherein the motorized detection rotating support is configured to orient the obstacle detection unit around at least two axes of rotation that are perpendicular to one another.

5. The obstacle detection assembly of claim 4, wherein one of the axes of rotation coincides with the yaw axis of the drone.

6. The obstacle detection assembly of claim 1, wherein the motorized detection rotating support is configured to orient the obstacle detection unit around three orthogonal axes of rotation.

7. The obstacle detection assembly of claim 1, wherein the orientation module is configured to determine the direction of movement of the drone.

8. The obstacle detection assembly of claim 7, wherein the orientation module is configured to determine the direction of movement as a function of piloting instructions received by the drone, data supplied by a geolocation device of the drone, an inertial measurement unit of the drone, or a combination of the foregoing.

9. The obstacle detection assembly of claim 1, wherein the obstacle detection unit bears two obstacle detection sensors that are stereovision cameras.

10. The obstacle detection assembly of claim 1, wherein the at least one obstacle detection sensor is a telemetry sensor.

11. The obstacle detection assembly of claim 10, each of the at least one obstacle detection sensors is independently selected from the group consisting of an optical telemetry sensor, an acoustic telemetry sensor, and a radar telemetry sensor.

12. A drone comprising the obstacle detection assembly of claim 1, wherein the detection rotating support is fastened to the drone.

13. A method for detecting obstacles in a path of a rotary wing drone, the method comprising controlling a motorized detection rotating support mounted on the drone, wherein the motorized detection rotating support bears an obstacle detection unit having at least one obstacle detection sensor and having a line of sight, to orient the line of sight of the obstacle detection unit as a function of a movement direction of the drone.

14. The method of claim 10, wherein the control of the motorized detection rotating support is such that a projection of the line of sight on a reference plane defined by the roll axis and the pitch axis of the drone coincides with a projection of the movement direction of the drone on this reference plane.

15. The method of claim 10, wherein the control of the motorized is such that a projection of the line of sight on a horizontal plane coincides with an orthogonal projection of the movement direction of the drone on the horizontal plane.
